(19) United States
(12) Patent Application Publication
(10) Pub. No.: US 2009/0254571 A1
(43) Pub. Date: Oct. 8, 2009

(54) SYSTEM AND METHOD OF SYNCHRONIZING DATA SETS ACROSS DISTRIBUTED SYSTEMS

(76) Inventors: David A. Cassel, Madison, WI (US); Athanassios K. Tsiolis, McFarland, WI (US); Vassil D. Peytchev, Madison, WI (US); Timothy W. Escher, Lodi, WI (US); James Thuesen, Blue Mounds, WI (US); Jason L. Hansen, Madison, WI (US); Clifford L. Michalski, Oregon, WI (US)

Correspondence Address: MARSHALL, GERSTEIN & BORUN LLP, 233 S. Wacker Drive, Suite 6300, Sears Tower, Chicago, IL, 60606-6357, US

(21) Appl. No.: 12/412,535

(22) Filed: Mar. 27, 2009

Related U.S. Application Data
(63) Continuation of application No. 10/795,634, filed on Mar. 8, 2004.

(51) Int. Cl. G06F 7/06; G06F 17/30

(52) U.S. Cl. 707/10; 707/104.1; 707/9; 707/E17.014; 707/E17.032

(57) ABSTRACT

An information management system comprising a first deployment that includes at least one data structure and a plurality of data sets stored on the data structure wherein each data set includes data items, at least a first subset of the data sets assigned an active status and at least a second subset of the data sets assigned a hibernating status, wherein active data sets and items within active data sets are accessible via both selection by a system user and via reference within other data sets and, wherein hibernating data sets and items within hibernating data sets are only accessible via reference from within other data sets.

### CROSS-REFERENCE TO RELATED APPLICATIONS

This application is a continuation of U.S. patent application Ser. No. 10/795,634, entitled “System And Method For Providing Patient Record Synchronization In A Healthcare Setting” filed on Mar. 8, 2004; and claims the benefit of the following U.S. Provisional Applications: Ser. No. 60/507,419, entitled “System And Method For Providing Patient Record Synchronization In A Healthcare Setting” filed Sep. 30, 2003, Ser. No. 60/519,389, entitled “System And Method Of Synchronizing Data Sets Across Distributed Systems” filed Nov. 12, 2003, Ser. No. 60/533,316, entitled “System And Method Of Synchronizing Category Lists And Master Files Across Distributed Systems” filed Dec. 30, 2003 (attorney docket no. 29794/39682A), the disclosures of which are hereby expressly incorporated herein by reference.

### TECHNICAL FIELD

This patent relates generally to synchronizing sets of data across a plurality of distributed systems, and more particularly, this patent relates to a system and method for providing an information sharing architecture that allows for the synchronization of data sets across server environments.

### BACKGROUND

Many healthcare professionals and most healthcare organizations are familiar with using information technology and accessing systems for their own medical specialty, practice, hospital department, or administration. While the systems servicing these entities have proven that they can be efficient and effective, they have largely been isolated systems that have managed electronic patient data in a closed environment. These systems collected, stored, and viewed the data in homogenous and compatible IT systems often provided by a single company. Minimal, if any, connections to the outside world or “community” existed, which eased the protection of patient data immensely. Current interfaces commonly used to communicate between systems have inherent limitations.

Increased computerization throughout the healthcare industry has given rise to a proliferation of independent systems that store electronic patient data. The proliferation of independent systems, and the resulting increases in electronic patient data, requires that patient records must be accessible in multiple systems. Furthermore, the data structures underlying the patient record (including but not limited to order information, allergens, providers, insurance coverage, and physician observations and findings—such as blood pressure, lung sounds, etc.) must also be synchronized in multiple systems to provide content for patient records. Many existing systems are capable of accessing data from others within their system; however, these islands of information are typically not capable of linkage and sharing of information with other islands in the community. Furthermore, as more systems are interconnected, the linkages and sharing problems increase exponentially and become unmanageable.

Previously, such sharing was done either by exchange of non-discrete data elements (in a textual form for example), or by means that would require manual intervention in order to parse and discretely store the exchanged data in each organization's repositories. In addition, attempts to provide a mapping service between each system and the others in the community proved insufficient to meet the unique needs of each system.

The sharing of electronic data among disparate entities is desirable and highly beneficial. In this work we present an approach that can facilitate such an exchange among members of a predefined set of systems—a community.

### BRIEF DESCRIPTION OF THE DRAWINGS

FIG. 1 is a schematic diagram illustrating an exemplary computer system that is consistent with at least some aspects of the present invention;

FIG. 2 is a schematic diagram illustrating the home deployment shown in FIG. 1 in greater detail;

FIG. 3 is a schematic diagram illustrating data being synchronized by both a patient record synchronization systems and a set of index servers that is consistent with at least some aspects of the present invention;

FIG. 4A illustrates an exemplary topology for a community implemented using the components shown in FIG. 1;

FIGS. 4B and 4C illustrate additional exemplary or alternative topologies that may be supported by the system of FIG. 1;

FIG. 5 illustrates an exemplary diagram of an EMFI record and item classifications that are consistent with at least some aspects of the present invention;

FIG. 6 illustrates an exemplary graph or representation of a relationship among different item classifications within a master file that is consistent with at least some aspects of the present invention;

FIG. 7 illustrates an exemplary flow diagram of several steps used to generate a community ID;

FIG. 8A lists the default logic for determining the hibernation status of a new shared object;

FIG. 8B provides a table including exceptions to the default logic shown in FIG. 8A;

FIG. 8C includes a table that lists additional exceptions to the defaults of FIG. 8A;

FIG. 9 an exemplary illustration of the default status of data sets when they are sent to a deployment;

FIG. 10 illustrates use interface messages to create and update a community shared static record;

FIG. 11 illustrates an early communication diagram with inclusion of a sample message format in communication lines;

FIG. 12 illustrates an example of use of a record for interfaces; and

FIG. 13 an exemplary graphical representation of a publish/subscribe communication model that is consistent with at least some aspects of the present invention.

### DETAILED DESCRIPTION

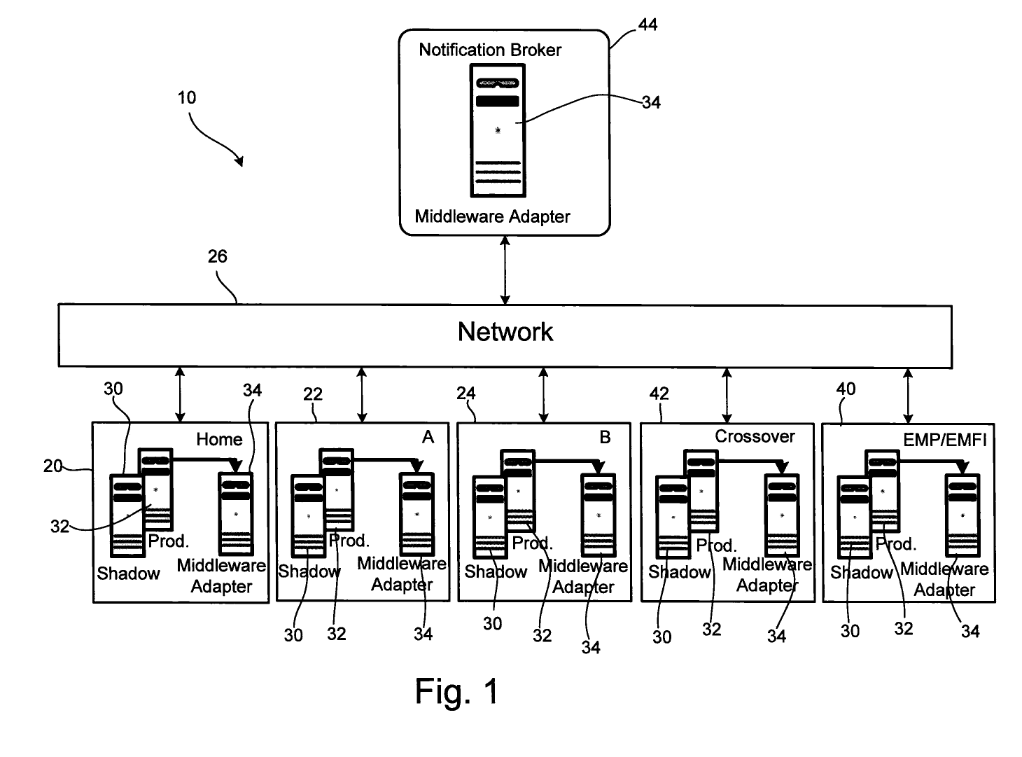

FIG. 1 illustrates an embodiment of an exemplary system 10 to provide an information sharing architecture that allows physically separate healthcare information systems, called “deployments,” to share and exchange information. The collection of these participating deployments is referred to as the “Community,” and systems within the Community sometimes store records for patients in common. The system 10 allows participants in the Community to share information on data changes to these patients, and to reconcile concurrent and conflicting updates to the patient's record.

The system 10 of FIG. 1 shows three deployments 20-24, labeled Home, A, and B. Home deployment 20 is operatively coupled to deployments A 22 and B 24 via the network 26. The deployments 20-24 may be located, by way of example rather than limitation, in separate geographic locations from each other, in different areas of the same city, or in different states. Although the system 10 is shown to include the deployment 20 and two deployments A 22 and B 24, it should be understood that large numbers of deployments may be utilized. For example, the system 10 may include a network 26 having a plurality of network computers and dozens of deployments 20-24, all of which may be interconnected via the network 26.

Each record that is exchanged throughout the system may be managed, or “owned,” by a specific deployment. The deployment owning a record is referred to as the record's “home deployment.” When a record is accessed for the first time from a deployment other than its home deployment, referred to as a “remote deployment,” the home deployment may send a copy of the record to the requesting remote deployment. The remote deployment may send its updates to the home deployment. The home deployment may coordinate the updates it receives from remote deployments by checking for conflicting data, before publishing the consolidated updates back to the Community of deployments. While the home deployment may have greater responsibility for the records it stores and manages there, it has no greater role in the general system than do the other deployments.

By convention, examples throughout this patent involve records homed on the deployment 20 labeled Home. It is important to note that the use of Home as the basis for examples would seem to suggest an inherently greater role for the home deployment 20. In fact, all three deployments 20-24 are peers, and each act as home to a subset of the system 10's records. In other words, “home” is merely an arbitrary convention for discussion.

At any given time, the home deployment for a given patient record may need to be changed because the patient moved or for some other infrastructural reason. A utility may be provided to allow authorized users at the home deployment to search for a patient record homed there and initiate a re-home process for the patient record.

The network 26 may be provided using a wide variety of techniques well known to those skilled in the art for the transfer of electronic data. For example, the network 26 may comprise dedicated access lines, plain ordinary telephone lines, satellite links, local area networks, wide area networks, frame relay, cable broadband connections, synchronous optical networks, combinations of these, etc. Additionally, the network 26 may include a plurality of network computers or server computers (not shown), each of which may be operatively interconnected in a known manner. Where the network 26 comprises the Internet, data communication may take place over the network 26 via an Internet communication protocol.

The deployments 20-24 may include a production server 30, a shadow server 32, and a dedicated middleware adaptor 34. The production server 30 and shadow server 32 may be servers of the type commonly employed in data storage and networking solutions. The servers 30 and 32 may be used to accumulate, analyze, and download data relating to a healthcare facility's medical records. For example, the servers 30 and 32 may periodically receive data from each of the deployments 20-24 indicative of information pertaining to a patient.

The production servers 30 may be referred to as a production data repository, or as an instance of a data repository. Due to the flexibility in state-of-the-art hardware configurations, the instance may not necessarily correspond to a single piece of hardware (i.e., a single server machine), although that is typically the case. Regardless of the number and variety of user interface options (desktop client, Web, etc.) that are in use, the instance is defined by the data repository. Enterprise reporting may be provided in some cases by extracting data from the production server 30, and forwarding the data to reporting repositories. In other cases, the data repositories could exist on the same server as the production environment. Accordingly, although often configured in a one-to-one correspondence with the production server 30, the reporting repository may be separate from the production server 30.

The shadow servers 32 are servers optionally dedicated as near-real time backup of the production servers 30, and are often used to provide a failover in the event that a production server 30 becomes unavailable. Shadow servers 32 can be used to improve system performance for larger systems as they provide the ability to offload display—only activity from the production servers 30.

The deployments 20-24 may also include a middleware adapter machine 34 which provides transport, message routing, queuing and delivery/processing across a network for communication between the deployments 20-24. To allow for scaling, there may be several middleware adapters 34 that together serve a deployment. For purposes of this discussion, however, all machines that form a “pairing” (production server 30 and one or more middleware adapters) will be collectively referred to as a deployment. The presence of the middleware adapters 34 is not essential to this discussion and they are shown only as a reminder that messaging is necessary and present, and for uniformity with examples/diagrams.

As the patient is the center of each healthcare experience, the information to be exchanged revolves around the patient and grows into a number of areas that, while related (they apply to the patient), serve different and distinct purposes. This includes, for example, the exchange of clinical information. However, the system provides techniques and conventions for the exchange of non-clinical information as well, including information outside the healthcare domain altogether. As used herein, the term “record” generally refers to a collection of information that might extend beyond the clinical information some might typically expect to make up a medical chart, per se.

The two types of records that most require ID tracking/management are patient records (a single file for each patient), and master file records. In this document “master file” denotes a database (a collection of data records) which is relatively static in nature, and which is primarily used for reference purposes from other more dynamic databases. For example, a patient database is relatively dynamic, growing and changing on a minute-by-minute basis; dynamic databases are comprised of records that are created as part of the workflow of software applications, such as orders and medical claims. On the other hand, a reference list of all recognized medical procedure codes, or of all recognized medical diagnoses, is relatively more static and is used for lookup purposes, and so would be referred to as a master file.

Administrators are able to assign community-wide unique identifiers to each deployment. This is important to uniquely identify a deployment when processing incoming and outgoing messages for patient synchronization. These settings are used to notify all the deployments of the software version of each deployment in the Community. This helps to effectively step up or step down version-dependent data in the synchronization messages.

Any changes to a deployment's software version are published to the Community, so that each deployment is aware of the change. Administrators are able to activate and deactivate deployments in a Community. This way, a deployment can start or stop participating in the Community at any time.

Those persons of ordinary skill in the art will appreciate that every event in a patient record has information stored in it to easily determine the deployment that owns the event. This may be the deployment that created the event in the patient record.

The crossover server 42 allows deployments to operate at differing release versions of system software. The crossover server 42 provides storage/management for records that are extended beyond the data model available at their home deployments. The crossover server 42 allows a good deal of autonomy at the deployment level in that it provides the latitude for deployments to upgrade their version of system software on different timelines.

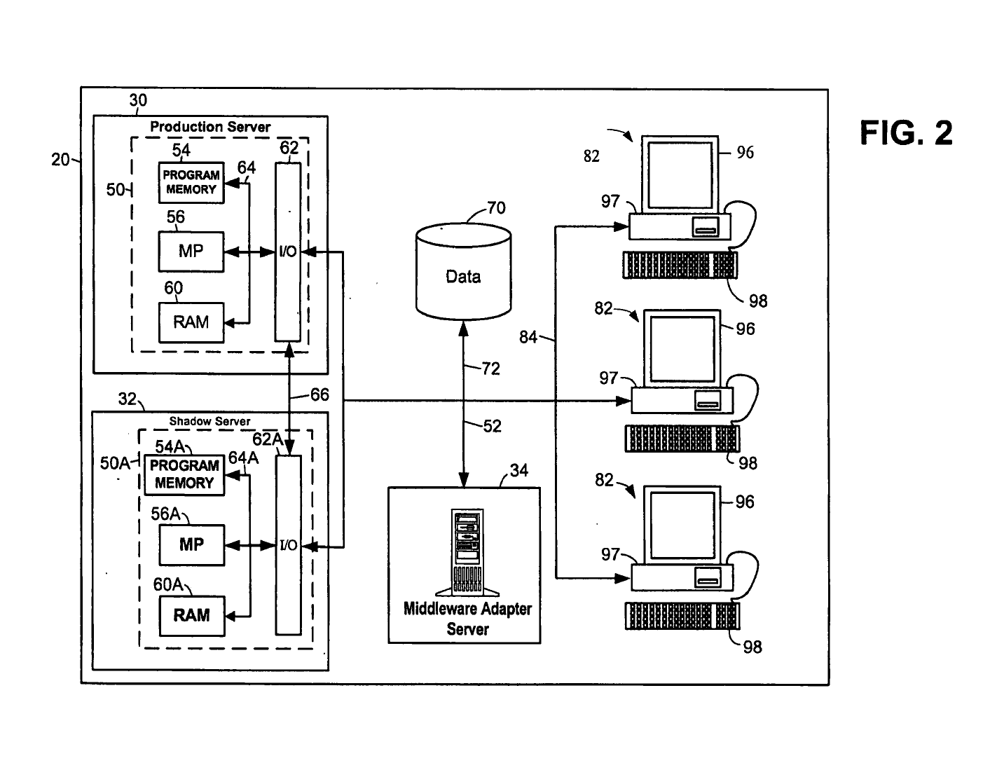

FIG. 2 is a schematic diagram 20 of one possible embodiment of several components located in deployment 20 labeled Home from FIG. 1. One or more of the deployments 20-24 from FIG. 1 may have the same components. Although the following description addresses the design of the healthcare facilities 20, it should be understood that the design of one or more of the deployments 20-24 may be different than the design of other deployments 20-24. Also, deployments 20-24 may have various different structures and methods of operation. It should also be understood that the embodiment shown in FIG. 2 illustrates some of the components and data connections present in a deployment, however it does not illustrate all of the data connections present in a typical deployment. For exemplary purposes, one design of a deployment is described below, but it should be understood that numerous other designs may be utilized.

One possible embodiment of one of the production servers 30 and one of the shadow servers 32 shown in FIG. 1 is included. The production server 30 may have a controller 50 that is operatively connected to the middleware adapter 34 via a link 52. The controller 50 may include a program memory 54, a microcontroller or a microprocessor (MP) 56, a random-access memory (RAM) 60, and an input/output (I/O) circuit 62, all of which may be interconnected via an address/data bus 64. It should be appreciated that although only one microprocessor 56 is shown, the controller 50 may include multiple microprocessors 56. Similarly, the memory of the controller 50 may include multiple RAMs 60 and multiple program memories 54. Although the I/O circuit 62 is shown as a single block, it should be appreciated that the I/O circuit 62 may include a number of different types of I/O circuits. The RAM(s) 60 and program memories 54 may be implemented as semiconductor memories, magnetically readable memories, and/or optically readable memories, for example. The controller 50 may also be operatively connected to the shadow server 32 via a link 66. The shadow server 50A, if present in the deployment 20, may have similar components, 50A, 54A, 56A, 60A, 62A, and 64A.

All of these memories or data repositories may be referred to as machine-accessible mediums. For the purpose of this description, a machine-accessible medium includes any mechanism that provides (i.e., stores and/or transmits) information in a form accessible by a machine (e.g., a computer, network device, personal digital assistant, manufacturing tool, any device with a set of one or more processors). For example, a machine-accessible medium includes recordable/non-recordable media (e.g., read only memory (ROM); random access memory (RAM); magnetic disk storage media; optical storage media; flash memory devices), as well as electrical, optical, acoustical or other form of propagated signals (e.g., carrier waves, infrared signals, digital signals); etc.

The deployments 20-24 may have a data repository 70 via a link 72, and a plurality of client device terminals 82 via a network 84. The links 52, 66, 72 and 84 may be part of a wide area network (WAN), a local area network (LAN), or any other type of network readily known to those persons skilled in the art.

The client device terminals 82 may include a display 96, a controller 97, a keyboard 98 as well as a variety of other input/output devices (not shown) such as a printer, mouse, touch screen, track pad, track ball, isopoint, voice recognition system, etc. Each client device terminal 82 may be signed onto and occupied by a healthcare employee to assist them in performing their duties.

Typically, the servers 30, 32 store a plurality of files, programs, and other data for use by the client device terminals 82 and other servers located in other deployments. One server 30, 32 may handle requests for data from a large number of client device terminals 82. Accordingly, each server 30, 32 may typically comprise a high end computer with a large storage capacity, one or more fast microprocessors, and one or more high speed network connections. Conversely, relative to a typical server 30, 32, each client device terminal 82 may typically include less storage capacity, a single microprocessor, and a single network connection.

### Overall Operation of the System

One manner in which an exemplary system may operate is described below in connection with several block diagram overviews and a number of flow charts which represent a number of routines of one or more computer programs.

As those of ordinary skill in the art will appreciate, the majority of the software utilized to implement the system is stored in one or more of the memories in the controllers 50 and 50A, or any of the other machines in the system 10, and may be written at any high level language such as C, C++, C#, Java, or the like, or any low-level, assembly or machine language. By storing the computer program portions therein, various portions of the memories are physically and/or structurally configured in accordance with the computer program instructions. Parts of the software, however, may be stored and run locally on the workstations 82. As the precise location where the steps are executed can be varied without departing from the scope of the invention, the following figures do not address which machine is performing which functions.

### Overview of Index Servers

Patient record synchronization needs, along with business logic needs, will dictate that certain sets of data be present in all production systems in the organization. For example, for performance reasons, the patient record synchronization process referenced in U.S. Provisional Application Ser. No. 60/507,419, entitled “System And Method For Providing Patient Record Synchronization In A Healthcare Setting,” filed Sep. 30, 2003 (attorney docket no. 29794/39410), the disclosure of which is hereby expressly incorporated herein by reference, will take the approach of expecting a physician record referenced by a patient record to exist at the target deployment. This patent ensures that the patient record synchronization process does not need to transfer any details about physician records referenced by the patient record to its target destination. As an additional example, the business logic decision for all participants of the community to order clinical tests from a superset of tests available to all deployments will be implemented by making the superset of tests available in all deployments.

While the system and method of patient record synchronization described above is used to transfer and synchronize patient-specific information non-patient-specific data is synchronized across multiple server environments by means of a set of index servers. The breadth of information contained in the non-patient specific data includes, but is not limited to, clinical, financial, risk management (insurance), and registration, as well as such organizational data as facility structures, departments, employees, workstations, and other such items.

The function of an index server can be seen to fill two roles for an organization:
Index servers function as synchronization tools. One of their functions is to coordinate communication about tracked items. Tracked items are pieces of data that are synchronized across systems in the community. Any appropriate changes to tracked information are communicated from the environment in which the change is made, through the index server, to all other environments. Any outdated, preexisting data in the receiving environments is replaced by the updated data.
Index servers function as broadcasting tools. Any new data sets created in any environments are communicated from the environment in which the data is entered, through the index server, to all other environments. Appropriate actions are taken in each receiving environment to store the new data set in an appropriate manner.

In the present embodiment, two index servers exist, an Enterprise Master File Index (EMFI) and an Enterprise Master Category Index (EMCI). These servers are sufficient to synchronize all necessary data sets between environments. A person of ordinary skill would be able to devise additional index servers to synchronize different sets of data as needed, or to modify existing index servers to accommodate unique characteristics of the data. In one possible embodiment, provisions are included in the index servers to specify custom processing functions for each data set or item in a data set.

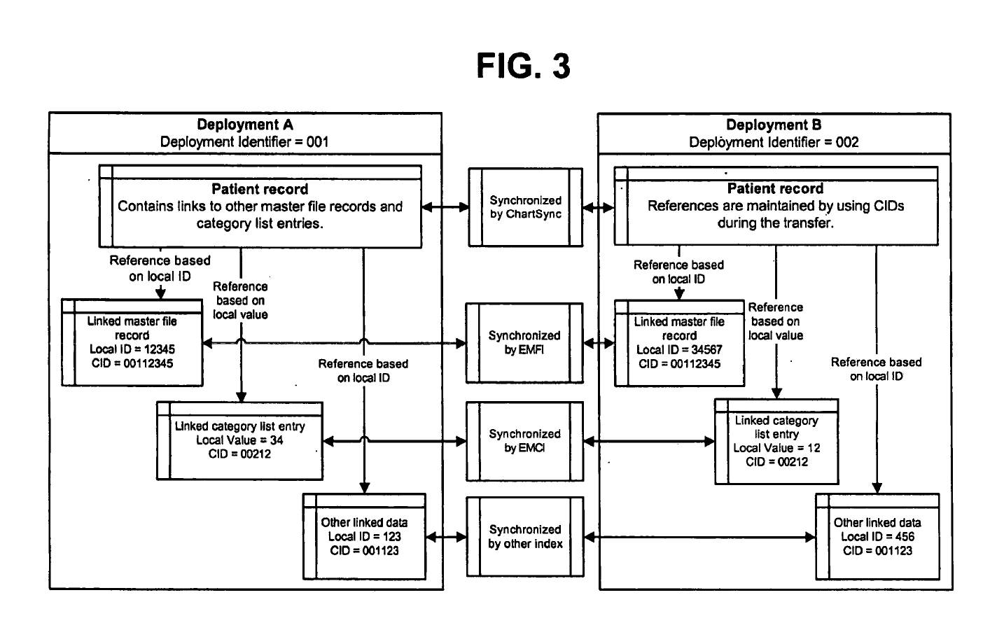

FIG. 3 illustrates an exemplary diagram of data being synchronized by both the patient record synchronization system and a set of index servers. The patient record on Deployment A references data in master file records and in category lists that exist on Deployment A. These master file records and category list entries may be synchronized across all deployments by their appropriate index servers. When the record is transferred to Deployment B, the references may be translated to the local versions of the master file records and category list entries. This allows references in the patient record to external data sets to be valid in any deployment, even if the local identifiers for the data are different.

In addition, the system hosting the index server serves as a centralized repository for all shared data sets. In the event that the index server becomes unavailable, any other system in the Community can be configured to serve as the index server. Any messages generated while the index server is unavailable remain in a queue until they can be received by a new or restored index server.

### Functions and Concepts Used by the Index Servers Community/Neighborhood/Deployment Topology

The index servers operate in a Community Model of distributed systems operating in separate environments. The Data sets from any environment are synchronized in all other environments, without regard to the relationships between the environments, but the logic used to determine the hibernation status of the data sets does rely on a hierarchical relationship between systems.

The systems and environments between which data sets are synchronized may be owned by the same entity or organization, or may be owned by different entities or organizations. In the former case, the Community Model allows for data synchronization in a geographically dispersed organization. In the later case, the Community Model allows for data synchronization between multiple entities or organizations.

In one embodiment, the hierarchy consists of three levels: the community, neighborhood, and deployment. Multiple entries can be made at each level, including the community level. Additional layers can be created by defining, for example, nested neighborhood levels. Each level may contain a set of system settings, which are applied to levels below them.

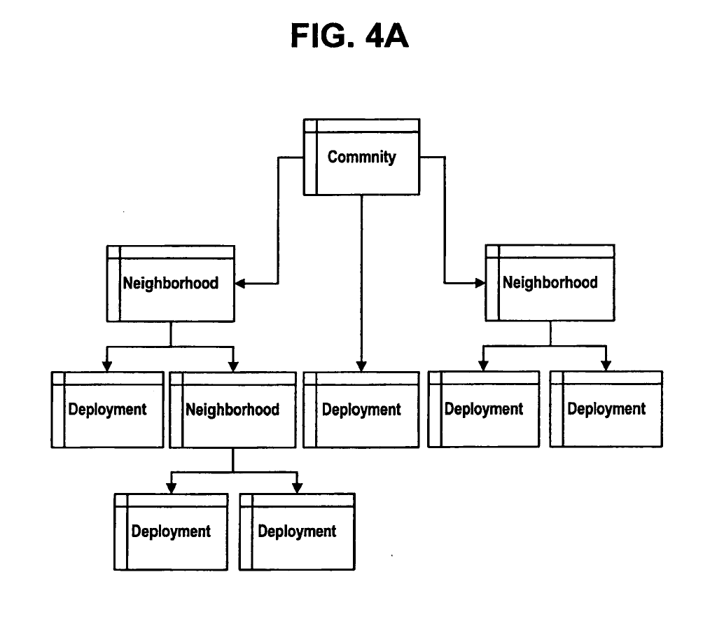

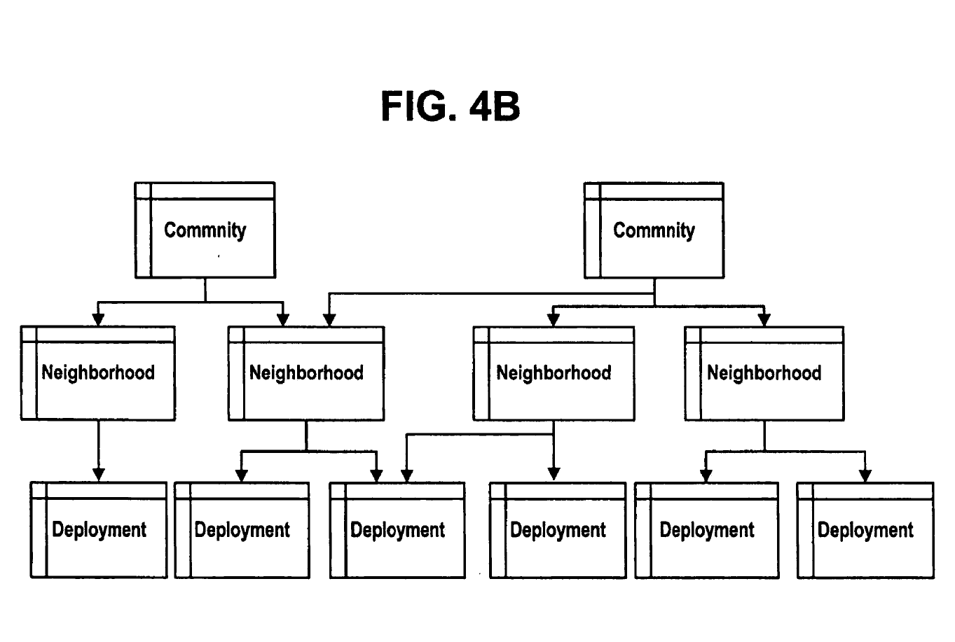

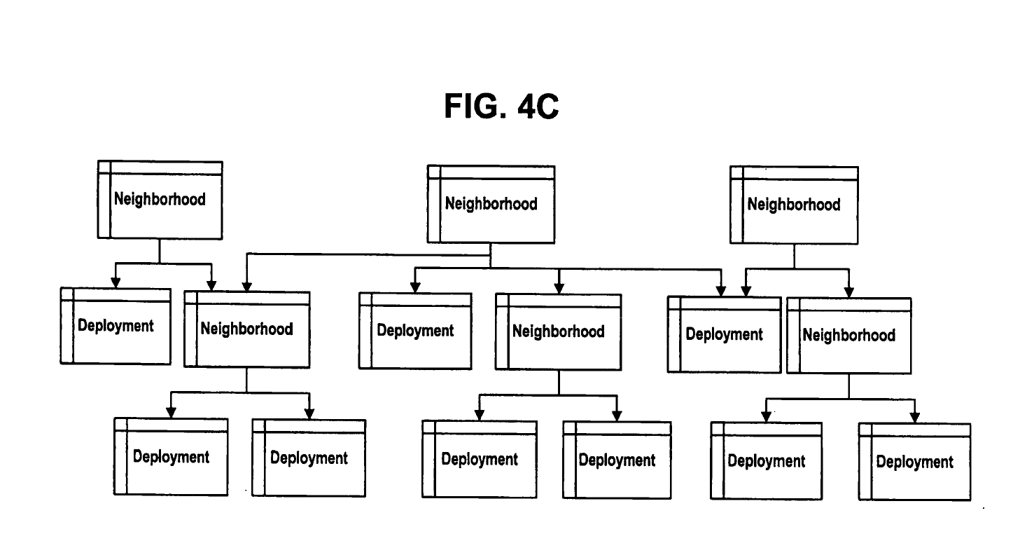

FIG. 4A illustrates an exemplary topology for the Community. Note that the index servers are located on a separate server environment in this diagram. Based on the needs of the particular implementation of the system, each index server can be located on a separate environment. In a Community with only one community level environment, the index servers may be in the community environment.

Alternate topologies can be implemented by assigning a deployment directly to a community, by omitting the community level, or by assigning a deployment to multiple neighborhoods or communities. FIGS. 4B and 4C illustrate examples of alternative topologies supported in the system.
Community environments are the top level of the hierarchy. Multiple communities can exist in the Community Model. System-level settings are recorded at the community level, such as whether patient record synchronization is enabled.

Communities are concepts; there are no community server environments. Instead, you can define a deployment in each community as the community lead. When the community lead deployment is the home deployment for a data set, it determines the values of the record's community tracked items throughout the Community Model. Community tracked items are a subtype of tracked items that are tracked at the community level.
Neighborhood environments define groups of deployments and neighborhoods. If you need to create additional layers in your community model hierarchy, you can use nested neighborhoods to do so.

Neighborhoods are concepts; there are typically no neighborhood server environments. Instead, you can define a deployment in each neighborhood as the neighborhood lead. The neighborhood lead is similar to the community lead, but has a smaller scope of control that it exercises over a smaller subset of deployments. When the neighborhood lead is the home deployment for a record, changes to the community tracked and neighborhood tracked items in the records are broadcast by the index server. The changes to neighborhood tracked items are only accepted by deployments in the neighborhood, however. When another deployment is the home deployment for the record, it can be configured so that only changes to the neighborhood tracked items are broadcast from the index server.
Deployment environments define related groups of facilities that share a common production environment, such as a hospital and its related clinics. Specialized elements in the community model, such as the index server and the crossover server, are also defined as deployments. One unique set of deployment-level settings is applied to each environment.

For most end users, use of the system is restricted to their own local deployment. For administrators with access to multiple deployments, however, the choice of which deployment the administrator logs in to determines how the data is distributed through the index server. In one embodiment, the structures in the topology are defined by master file records. These records are synchronized by the EMFI. An alternate index server may be used to synchronize topology data that is recorded in other data sets. In each environment, it may be that only one deployment record is active; this record defines the environment for the Community Model. The other deployment records are inactive, and are only used for community with the community, neighborhoods, and other deployments.

### Types of Synchronized Data

In most implementations of the system, it is neither necessary nor desirable to synchronize all available data across environments, although the system can be set up to synchronize all data.

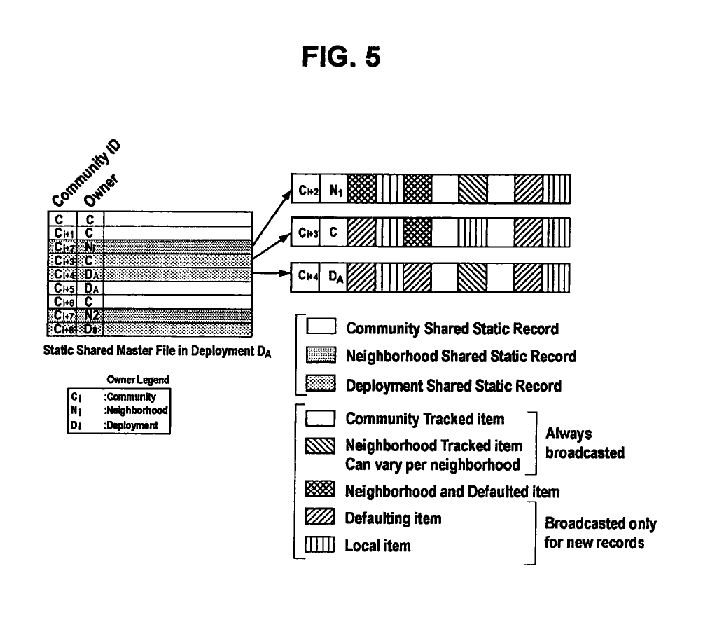

FIG. 5 illustrates an exemplary diagram of EMFI Record and Item classifications.
A master file or a category list is classified as shared static if its records or entries, respectively, are assumed to be present in all deployments that participate in the community model (shared) and do not change very often (static). The static identity of a shared object can be influenced by business decisions, such as the requirement of control over a set of objects. From a functional standpoint, the difference between static and dynamic objects is best seen in example: a record that functions as a template (default settings for all orders of a specific medication) is static; a record based on the static record (a specific order for that medication, placed for a patient) is dynamic.
Not all items within a record of a shared master file need to be shared across deployments. The general assumption is that a subset of the record items are considered shared, while the rest of the record items are considered local. Assumptions cannot be made on the values of the local items (items that are active only within their deployment) of a shared record across deployment.

The EMCI may synchronize all information for category list entries. Category list entries may be small data sets that are used to keep lists of reference information comprising, for example, an ID, a Title, an Abbreviation, and Synonyms. A specific example is a list of potential Genders for a patient that could appear as follows:

| ID | Title | Abbreviation | Synonyms |
|---|---|---|---|
| 1 | Female | F | Woman, Girl, Lady, . . . |
| 2 | Male | M | Man, Boy, Gentleman, . . . |

While a plethora of other examples exist, a few include lists of states, lists of licensures, lists of ethnicities, etc. Some entries within a category list can be designated as secured by the developer, and then cannot be edited by customers or users (but the category itself may be edited—the restriction may apply only to the secured items within the list). As a result, it may be that only customer-created category list entries need to be synchronized. This reduces the number of update messages that need to be generated.

When a more robust list of reference information is desired, a master file may be utilized. The EMFI may be used to synchronize information in master file records. In master file records, the potential data set is much larger. Because a category is conceptually a simple case of a master file, a master file may have the same set of data as a category list entry. However, a master file is used when a reference list would benefit from maintaining more information about each item on the list, for example, a list of doctors, where a user would like to keep an expanded set of data items about each element on the list, such as doctors' office addresses, emergency beeper numbers, specialties, etc.

Master files can also be used to store other information, such as system settings. When used in this manner, the number of records in the master file may be limited to a single record, rather than a reference list of possible sets of system settings. It should be noted that not every item in a master file record needs to be synchronized at each deployment. Each item may be designated as one of several types of data with regard to how it is distributed through the EMFI. These definitions are not meant to represent all possible uses of these data sets-their dynamic nature allows for a large number of potential applications. Four exemplary types include:
Community Tracked items are synchronized at the community level. For new records, community tracked items are sent through the EMFI to receiving deployments. In addition, changes made to these items in the record's home deployment are broadcast to all other deployments in the community, and these changes overwrite the data in all deployments in the community. Each community may define its own set of community tracked items.

Neighborhood Tracked items are synchronized at the neighborhood level. For new records, neighborhood tracked items are sent through the EMFI to receiving deployments. However, changes made to these items in the record's home deployment may only broadcast to other deployments in the neighborhood, and these changes may overwrite the data in all deployments in the neighborhood. Each neighborhood may define its own set of neighborhood tracked items.
Deployment, or Local items are owned and updated at the local level, in the deployment. Changes made at the deployment level are not typically applied to any other deployment.

Default items can be owned and updated at any level. When the record is created, these items are sent to other deployments in the community. Afterwards, they are not updated through the EMFI. Once they have been sent the first time, the items can be updated at the local level in each deployment. Items that are tracked at the neighborhood level can also be designated as default items.

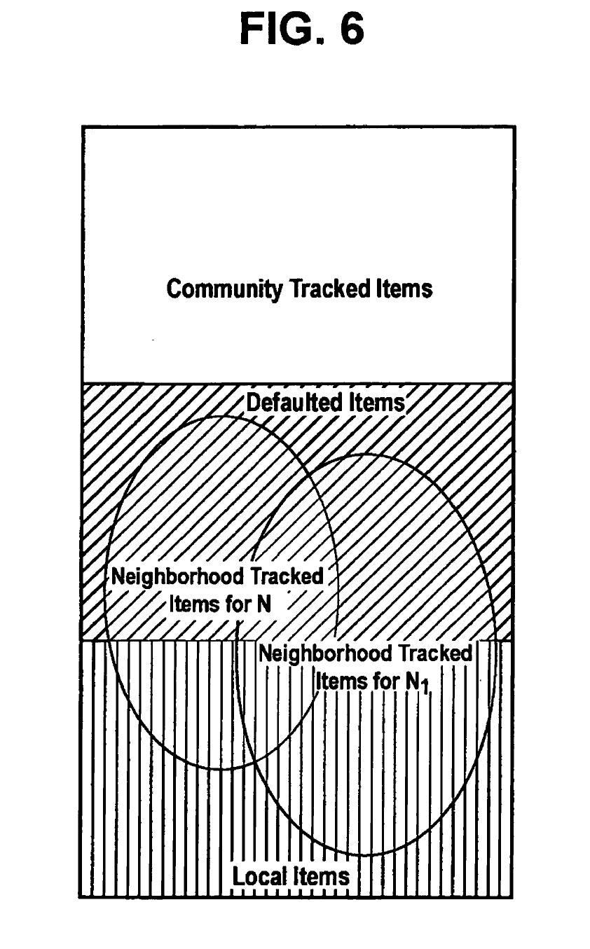

FIG. 6 illustrates an exemplary graphical representation of the relationship among the different item classifications within a master file. The neighborhood tracked items within a master file are neighborhood-specific (i.e., the neighborhood items for neighborhood N1 can be different from the neighborhood items for neighborhood N2.) Neighborhood and community tracked items cannot overlap. Neighborhood tracked items and defaulted items can overlap (i.e., a defaulted item can be within the group of a neighborhood's neighborhood tracked items.) A local item can be marked as a neighborhood tracked item within a neighborhood.

As mentioned above, each community contains a list of community tracked items, and each neighborhood contains a list of neighborhood tracked items. It is possible, while the system is operating, to modify these lists to begin tracking new items or stop tracking items. These changes are immediately put into effect in the systems as the change is made to their records.

Custom functions can be used by the index servers to synchronize additional data. One embodiment of the index server uses custom functions to attempt to synchronize the local record ID or the local values of category list items. For example, a category list is used to provide a list of languages that can be spoken by a patient or provider. Users may be in the habit of typing 10 to select English. Using this function, the EMCI tracks the local value of the category list entry and attempts to use the same value when broadcasting the entry to each receiving deployment. This ensures that the values, as well as the meanings of the references to those values, are consistent across deployments. If the value is already in use, then the next available value is used. Another use of custom functions is generating values for master file items that are an index of other tracked items. The tracked items are broadcast by the EMFI, and then the custom function is called to calculate the values for the index, based on the tracked items.

### Community IDs

Community IDs (CIDs) may be used to track synchronized data sets across environments. Data sets may be any collection of data that can be synchronized across distributed systems. In the disclosed embodiments, data sets may be records in a database, subsets of data items in a record, or the data sets may be entries in an enumerated or category list. The data sets discussed with reference to the disclosed embodiments encompass all methods of data storage. It should be noted that if additional methods were to be utilized, the additional methods would likely define additional synchronized data sets. When a new data set is created at a deployment, including specialized deployments such as the community lead, it is assigned a community unique record ID. The record ID or category value can serve as one basis for the generation of a CID.

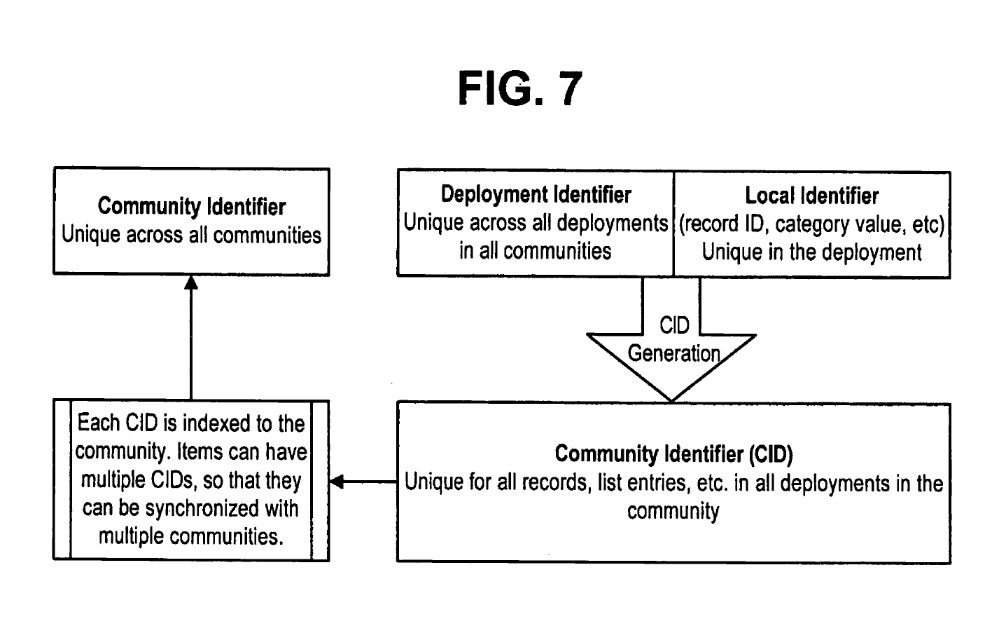

FIG. 7 illustrates an exemplary flow diagram of several steps used to generate a community ID. To ensure that the CID is unique across all deployments, each deployment may have a unique prefix defined for it. When a shared master file record is created at the deployment, this unique identifier may be prefixed to the local record ID or category value to generate the CID. This ensures that, with respect to other records in the master file or entries in the category list, the CID may be unique across all deployments.

Each CID may be indexed to the community in which it was created. A different CID may be used to track the data set in each community. Within each community, only one CID is typically used to identify the data set.

If a user copies a record to create a new record, it is assigned a unique CID. The CID is not copied from the original record.

Other methods of generating a unique identifier, such as serial numbers, can be enabled in the present embodiment. The CID need merely be unique in the community for all other data sets with which the data set could be confused. Custom methods of CID generation are supported at the system level.

### Home Deployments

Each shared data set may be assigned a home deployment when it is created. The home deployment identifies the deployment at which the data set was created, and this deployment is considered to own the data set.

In implementations that do not require centralized control over the data, home deployments need not be assigned to synchronized objects. This embodiment maximizes the ability of the index servers to synchronize data, as changes to tracked items made in any deployment are broadcast to all other deployments. This embodiment provides the most flexible arrangement for distributing changes to synchronized items.

Changes to synchronized items made in a data set's home deployment are communicated to the appropriate index server, and from there to the other deployments. Changes to synchronized items that are made in another deployment are moderated by a change authorization mechanism (see below).

If a user copies a record to create a new record, the deployment in which the user copies the record is the home deployment of the new record. The owner is not copied from the original record.

A conversion function and manual utility are provided to change the home deployment of data sets as needed. Changes to the home deployment of a data set are communicated to other deployments by the appropriate index server.

### Change Authorizations

The system contains numerous options for ensuring that only authorized changes are made to tracked data items, as described below. The more basic change authorization mechanism is employed for category list entries. The method used to edit category list entries checks the home deployment for the entry. If the current deployment is not the entry's home deployment, users are not permitted to edit the category list entry. This ensures that the data is not out of sync at the local deployment.

At least two methods of change authorization are available for master file records. In a first method, the system checks the home deployment of the record when a synchronized item is edited. If the current deployment is not the record's home deployment, the change is not communicated to the EMFI. This prevents unauthorized changes from being broadcast through the EMFI.

In a more advanced version of change authorization, when a tracked item (community or neighborhood, if defined for the deployment) of an existing shared static record is altered, and the deployment is not the owner of the record, the original value for the item is restored from the audit trail kept in the deployment, and a log of the attempted change is generated. No message to the EMFI is sent out of the deployment.

As illustrated, users at the local deployment can make any changes necessary to local items. They can also change the values provided for the default items. These changes are not usually communicated to the EMFI.

If changes are made to community tracked items or neighborhood tracked items, the EMFI may be informed of the change. Since the tracked items are only supposed to be edited in a record's home deployment, the EMFI may send the correct information to the deployment, effectively undoing the change. If a neighborhood were to send changes to a community-tracked item to the EMFI, the neighborhood's change could also be undone in a similar fashion.

### Hibernation

When a new data set is received by a deployment, it is assigned a hibernation status. The hibernation status can be either active or hibernating. Data sets that are hibernating can be referenced by other records, but are not included in search results made by users when they search for the data set. This reduces the impact of the new data sets on end users and their workflows, since they do not see new data sets if they are in hibernation. All references to hibernating objects and their items from within a patient record are allowed, so that information copied to the current deployment by the record synchronization process that is needed to review a patient record is available.

For example, consider a provider record that is sent to a deployment and placed in hibernation. If a patient record is viewed, and references that provider record, the system can identify the provider record and display the correct provider. If a report on the patient should display the name of the patient's PCP, the system can obtain that information and display it. However, the provider record cannot be selected by users. If a patient is being admitted to a hospital in one deployment, the list of providers for the patient's care team is limited to active provider records, and does not include records with a hibernation status. This limits the choices to a more reasonable set of providers.

Different methods are used to indicate the hibernation status of different sets of data. In one possible embodiment, an item in each master file record records the hibernation status, while hibernating category list entries are given negative category values. Other methods can be developed, as appropriate, for other data sets.

### Hibernation Rules and Exceptions

When a new data set is created, sent to the index server, and broadcast to the other deployments in the community, the status of the new data set in the receiving deployment is based on the deployment at which the record was created.

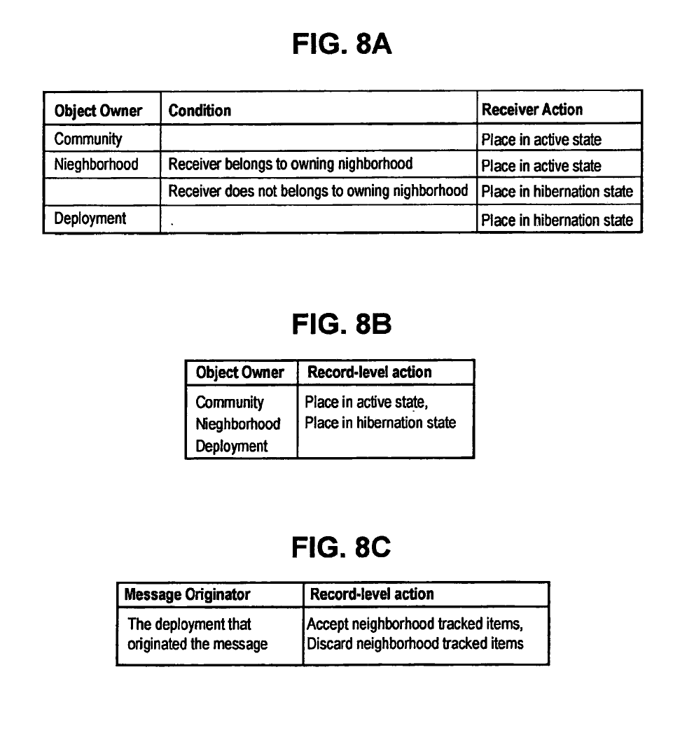

FIG. 8A lists the default logic for determining the hibernation status of a new shared object. If the message refers to a shared object that is not yet present in the receiver's environment, or if it refers to a shared object present in the in the receiver's environment but with a different owner than the one indicated in the message, this default logic may be used to determine the hibernation status of the object.

The default receiver's actions with regard to the item-level and record-level actions have been described above. Exceptions to these defaults can be implemented via two override tables shown in FIG. 8B: Receiver exceptions—record-level overrides and FIG. 8C: Receiver exceptions—item-level overrides.

A new record created in a deployment as a result of a deployment shared static record that was created in another deployment and then broadcast from the EMFI is placed in hibernation by default.

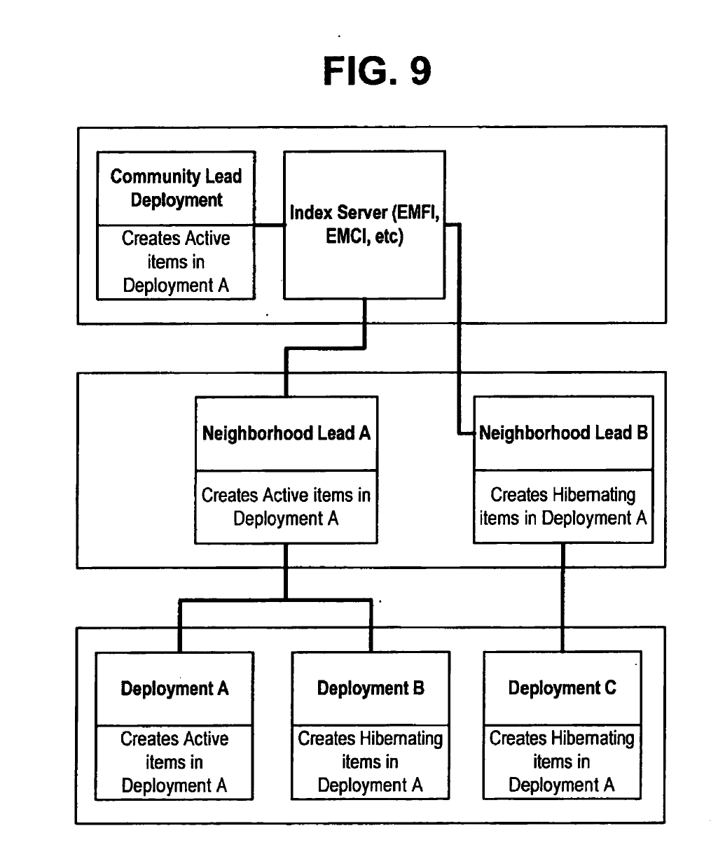

FIG. 9 is an exemplary illustration of the default status of data sets when they are sent to a deployment, in this case Deployment A. Note that all information is routed through the index server. If the data set was created in the community or neighborhood that contains the receiving deployment, it is active. If the data set is from another community or neighborhood, the data set is placed in hibernation at the receiving deployment.
1. In each deployment, a custom function can be used to determine the hibernation status of a type of data set. For example, records in a specific master file can use custom logic. If the function fails to return a hibernation status, the default logic described below is applied to the data set.
2. To account for atypical uses of the index servers, any data set that is sent to its home deployment is active. In most cases, the data set already exists and has an active status, and creating it generated the message to the index server. This rule cannot be overridden.
3. A set of Release Community Settings override the default behavior for all records in selected master files, across all communities. For some master files, new records are placed in hibernation when they are sent to a deployment from any other deployment, including the community lead. For other master files, new records are active in all deployments.
4. Exceptions to the default behavior for both master file records and category list entries can be recorded at the community, neighborhood, and deployment level, with more specific exceptions overriding those set at higher levels. Exceptions can be set up to apply to specific master files, category lists, and home deployments. For example, a deployment can indicate that all records sent from a deployment in a different neighborhood are made active in the deployment.
5. If none of the above rules and exceptions applies to the record or list entry, the default status, as illustrated in FIG. 9, is used.

### Manual Overrides for Hibernation Status

After new synchronized objects have been added to a deployment and assigned a status (active or hibernated), authorized entities can change this status within the receiving deployment. This functionality allows local authorities to (1) activate an existing hibernated object rather than create a new, duplicate object, which in turn reduces the use of duplicate concepts across the community, and (2) to ‘retire’ an active object originated by a remote deployment if the use of such an object is not compatible with the business needs and practices of the local deployment.

Note that in general, the indexing service will not automatically alter the status of an existing synchronized object at a receiving deployment when updates are made to the object.

The indexing service does provide an additional method via which object owners can globally retire objects from the entire community. An example of such a need is the need for removal of a recalled medication across all the community members.

When this method is invoked by the owner of the object, two actions take place at each receiving deployment. First, the object is assigned the hibernation status if it is currently active at the receiving deployment. Second, the object is marked as having been retired by its owner and can no longer be assigned the active status by any means within the control of the local deployment. The later action prevents users in the receiving deployments from re-activating the intentionally retired object.

### Workflows in Possible Embodiments General Function of the Index Server

The deployment from which the synchronization message originates is the originator of the message. Two actions trigger the index servers to automatically distribute shared data to the deployments:
1. A new shared static record or a new category list entry is created as part of a shared object.
2. A shared piece of information within a shared object is modified.
Two entities can cause the above listed actions:
1. A user within a particular deployment can alter a tracked item of a shared static object. For example, an administrator can create a new department.
2. An import of data at a centralized location can alter a tracked item of a shared object. For example, medication data from a third-party vendor can be imported into the system.

In addition, users can use a utility to manually initiate message generation to the index servers. The utility can send individual data sets or related groups of sets, such as all records in a master file or all entries for a category list. Filters can be applied on the utility to control the data sets that need to be propagated. Users can use this utility to send values for newly tracked items, records in newly synchronized master files, and data sets from new systems in the Community Model. In addition, the utility can be used to re-send messages if the index server is temporarily unavailable, or to overwrite unsynchronized data in other deployments.

Any of these events generate update messages from the EMFI/EMCI environment that will propagate the altered values to all deployments. These distributions can be done in:
Real-time—when a dataset is created or modified, it is immediately communicated to and processed by all community members.
Asynchronous (also called Delayed) Real-time—when a dataset is created or modified, the message is distributed by the EMFI/EMCI immediately, but when the processing of the change occurs is determined by each receiving deployment.
Batches—when a dataset is created or modified, the messages about the changes (and new items) are grouped, distributed, and processed together. A batch can be setup at either the index server or deployment level.

If necessary, different timing schemes can be used for sending messages to the index servers and sending messages from the index servers.

All messages from deployments may be sent to the EMFI; if the primary EMFI is unavailable, another deployment can be designated as the EMFI.

If a new shared static object is created at a deployment, a new owner is assigned to the object and the values for all of the tracked items (community and neighborhood, if defined for the neighborhood the deployment belongs to) along with the values for the defaulted items are sent to the index server.

If a deployment makes a change to an object it owns, the index server distributes the change. If a tracked item of an existing shared record is altered and the deployment is the owner of the record, all the community tracked items and the neighborhood tracked items—for all the neighborhoods to which the deployment may belong—are sent to the EMFI.

The index server may be the recipient of all of the messages from the originators. Upon receipt of a message, all of the data in the message (for all provided items) is stored in the index server and the message is broadcast to all deployments participating in the community model. Note that only messages that are supposed to be broadcast make it to the index server. Unauthorized alterations of records are suppressed and corrected at the originator deployment, according to the error correction technique employed at the deployment.

A receiver is the deployment that receives a message from the index server. Typically, a receiver can receive a message only from the index server. There are at least two decisions that the receiver can make that affect the processing of the information in the message:
Which groups of data to accept or reject
For new accepted objects, what hibernation status to assign to the object

If the receiver belongs to the same neighborhood as the originator of the shared object in the message, by default, both the neighborhood and the community tracked item values contained in the message get recorded in the receiver's copy of the object. The originator is included in the header of the message.

If the receiver does not belong to the same neighborhood as the originator of the object in the message, it may be that only the values of the community tracked items in the message get recorded in the receiver's copy of the object.

### BRIEF EXPLANATION OF USING INTERFACES TO COMMUNICATE

In one embodiment, communication between deployments is handled by a system of interfaces. The interface may be used by the shared object synchronization process can be a point-to-point interface. Deployments will be able to communicate with the index server, and the index server will be able to send messages to each deployment; thus, if N deployments participate in the initial community, there will be initially N bi-directional interfaces (or 2×N directed interfaces).

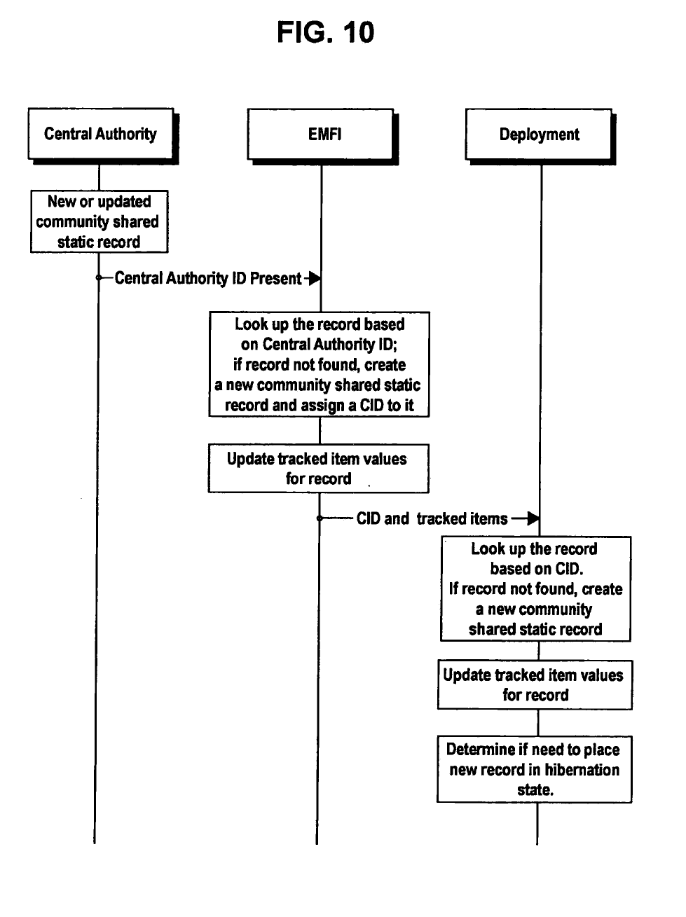

FIG. 10: illustrates the use of interface messages to create and update a community shared static record. Such records should be created by a central authority and marked as such during the creation process.

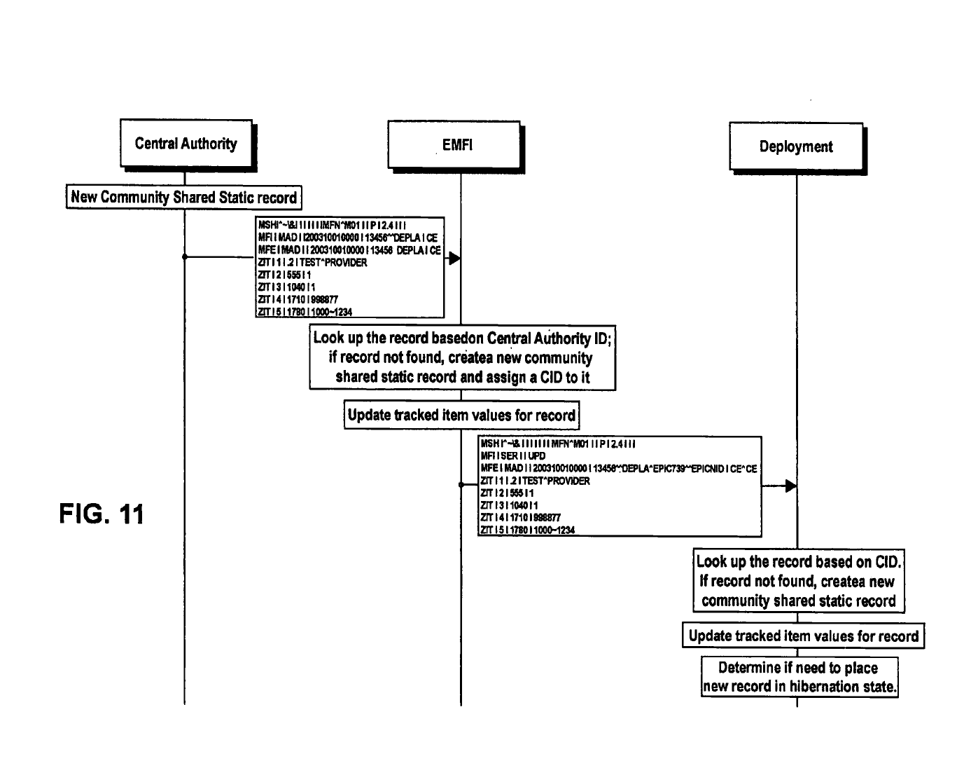

FIG. 11 shows the earlier communication diagram with inclusion of a sample messaging format in the communication lines.

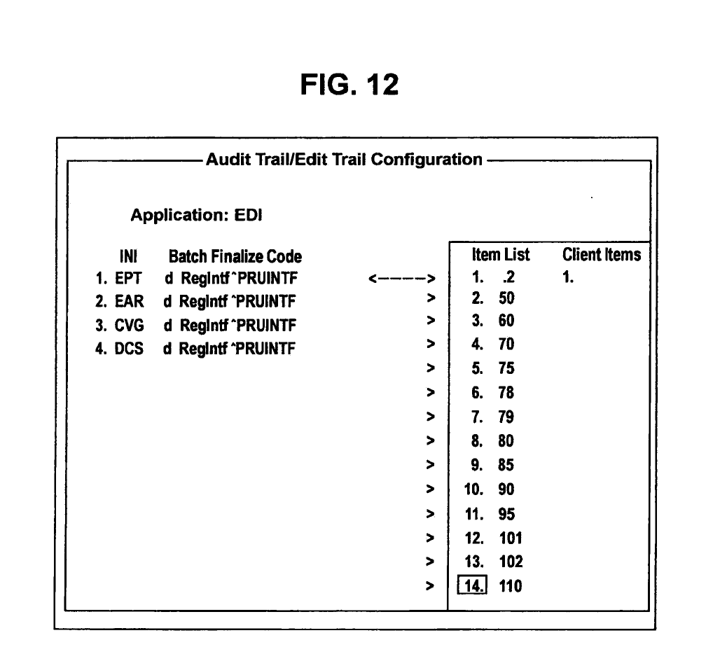

FIG. 12 illustrates an example of the use of a record for interfaces. The record contains a list of master files in which certain items are tracked at the community level. For each master file, a sub-list of community tracked items is recorded.

A special record meets the needs of the shared data synchronization process. This record contains all the shared static master files and the list of the tracked items within each of these master files. The code that is executed when a change in any of the tracked items within a shared static master file is detected (listed under the “Batch Finalize Code” column in FIG. 12) will initiate the shared data synchronization process.

When a synchronization message is processed at a target deployment, a standard import specification record is used to file the message into the respective shared master file. The import specification record to use for each of the shared master files is set as a parameter of the target deployment's incoming synchronization interface.

The import specification record defines the items that are updated and the method of updating the items for each update to a record in a shared master file that is processed in the target deployment. Special actions can be associated with each of the tracked items in the master file by using programming points that are executed when filing the value for the item. These actions can be used as local filters to control the filing of data sent from the EMFI to the deployment level.

### Brief Explanation of Using a Publication/Subscription System to Communicate

Another embodiment uses a publication/subscription system to manage communication between deployments.

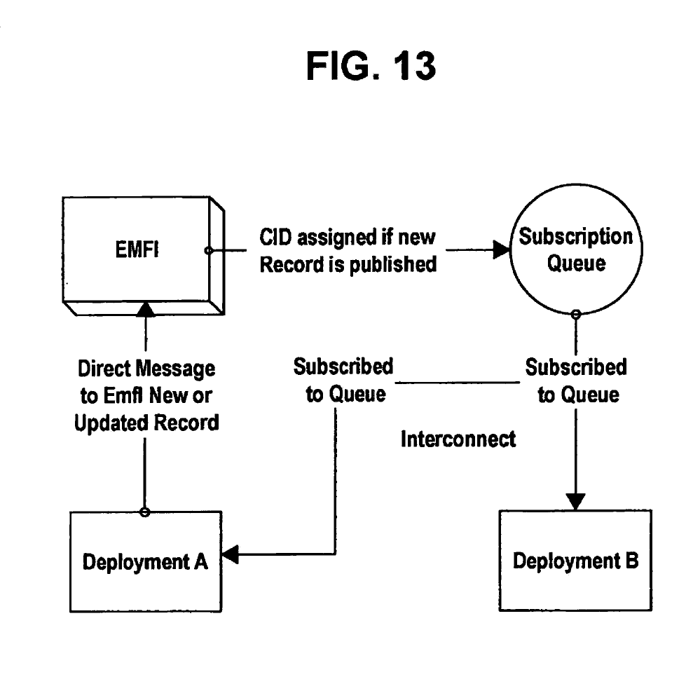

The point-to-point interfaces are replaced by a publish/subscribe communication model. FIG. 13 is an exemplary graphical representation of the design. A deployment may be able to communicate directly with the index server; however, the index server itself is publishing its communications to a special topic queue. All deployments subscribe to this topic so that they can receive all the updates published for shared records across the community.

In this embodiment, groups of items within each of the shared static master files will be used to track the need for and to initiate the shared data synchronization process. The triggering process will be based on similar techniques that will be used by the patient record synchronization process to determine the need for the publishing of changes on a patient record to which the deployment is subscribed.

Although the technique for providing healthcare organizations the ability to allow for the convenient and expedient transfer of patient information between separate healthcare systems described herein, is preferably implemented in software, it also may be implemented in hardware, firmware, etc., and may be implemented by any other processor associated with a healthcare enterprise. Thus, the routine(s) described herein may be implemented in a standard multi-purpose CPU or on specifically designed hardware or firmware as desired. When implemented in software, the software routine(s) may be stored in any computer readable memory such as on a magnetic disk, a laser disk, or other machine accessible storage medium, in a RAM or ROM of a computer or processor, etc. Likewise, the software may be delivered to a user or process control system via any known or desired delivery method including, for example, on a computer readable disk or other transportable computer storage mechanism or over a communication channel such as a telephone line, the Internet, etc. (which are viewed as being the same as or interchangeable with providing such software via transportable storage medium).

While the present invention has been described with reference to specific examples, which are intended to be illustrative only and not to be limiting of the invention, it will be apparent to those of ordinary skill in the art that changes, additions or deletions may be made to the disclosed embodiments without departing from the spirit and scope of the invention.

1. An information management system comprising:
a first deployment that includes at least one data structure and a plurality of data sets stored on the data structure wherein each data set includes data items, at least a first subset of the data sets assigned an active status and at least a second subset of the data sets assigned a hibernating status;
wherein active data sets and items within active data sets are accessible via both selection by a system user and via reference within other data sets; and
wherein hibernating data sets and items within hibernating data sets are only accessible via reference from within other data sets.

2. The system of claim 1 wherein hibernating data sets and items within hibernating data sets are only accessible via references from within other data sets where the references were established prior to the hibernating data set being rendered hibernating.

3. The system of claim 1 wherein, when the system is used to search for a specific data set, active data sets are included in the search and hibernating data sets are excluded from the search and wherein search results only include data items associated with the active data sets and exclude data items from the hibernating data sets.

4. The system of claim 1 wherein an active data set can be rendered hibernating and wherein references to an active data set and data items in the active data set become references to a hibernating data set and data items in the hibernating data set after the active data set is rendered hibernating.

5. The system of claim 4 wherein additional references to hibernating data sets cannot be made after an active data set is rendered hibernating.

6. The system of claim 1 wherein a hibernating data sets and data items in the hibernating data set can only be accessed via references thereto that were made prior to the data set being assigned a hibernating status.

7. The system of claim 1 further including a plurality of deployments, each deployment periodically originating a new data set and providing the new data set to the first deployment and, wherein, when a new data set is provided to the first deployment, one of the deployments assigns one of a hibernating status and an active status to the new data set for the first deployment.

8. The system of claim 7 wherein the one of the deployments that assigns a status to the new data set for the first deployment is the first deployment.

9. The system of claim 7 wherein the one of the deployments that assigns a status to the new data set assigns the status as a function of the identity of the deployment that originated the data set.

10. The system of claim 9 wherein a subset of the plurality of deployments comprises a first neighborhood, the first deployment is included in the first neighborhood deployments and wherein, when a new data set originated by a first neighborhood deployment is provided as the new data set to the first deployment, the one deployment assigns an active status to the new data set for the first deployment and, when a new data set originated by a deployment other than a first neighborhood deployment is provided to as the new data set to the first deployment, the one deployment assigns a hibernating status to the new data set for the first deployment.

11. The system of claim 10 wherein status of at least one data set can be manually altered.

12. The system of claim 10 wherein the one deployment that assigns status to new data sets that are provided to the first deployment further facilitates at least one exception wherein, when a new data set originated by a first neighborhood deployment is provided as the new data set to the first deployment and an exception condition occurs, the one deployment assigns a hibernating status to the new data set for the first deployment.

13. The system of claim 10 wherein the one deployment that assigns status to new data sets that are provided to the first deployment further facilitates at least one exception wherein, when a new data set originated by other than a first neighborhood deployment is provided as the new data set to the first deployment and an exception condition occurs, the one deployment assigns an active status to the new data set for the first deployment.

14. The system of claim 9 wherein a subset of the plurality of deployments comprises a first community, the first deployment is included in the first community deployments and wherein, when a new data set originated by a first community deployment is provided as the new data set to the first deployment, the one deployment assigns an active status to the new data set for the first deployment and, when a new data set originated by a deployment other than a first community deployment is provided to as the new data set to the first deployment, the one deployment assigns a hibernating status to the new data set for the first deployment.

15. The system of claim 8 wherein the first deployment also periodically originates and provides new data sets to other deployments and, wherein, when one of the other deployments receives a new data set from the first deployment, the receiving deployment assigns a status to the new data set as a function of the identity of the originating deployment.

16. The system of claim 7 wherein each deployment stores at least one specific data set and wherein an active status is assigned to the one specific data set for at least a first subset of the deployments and a hibernating status is assigned to the one specific data subset for at least a second subset of the deployments.

17. The system of claim 16 further including at least one deployment that can issue an override to assign a hibernating status to all instances of the one specific data subset associated with at least a deployment subset.

18. The system of claim 1 wherein a subset of the hibernated data sets each includes a single data item.

19. The system of claim 1 wherein at least a subset of the data sets each includes at least a portion of a complete record.

20. The system of claim 7 wherein the deployment that originates a data set is the owner of the data set.

21. An information management system comprising:
a first deployment that includes at least one data structure;
a second deployment that originates a data set where the data set includes data items, the second deployment providing the originated data set to the first deployment;
wherein, when the data set is provided to the first deployment, one deployment assigns one of a hibernating status and an active status to the data set;
wherein active data sets and items within active data sets are accessible via both selection by a system user and via reference within other data sets; and
wherein hibernating data sets and items within hibernating data sets are only accessible via reference from within other data sets.

22. The assembly of claim 21 wherein data items in active data sets and data items in hibernating data sets are accessible.

23. The assembly of claim 22 wherein the one deployment that assigns is the first deployment.

24. The assembly of claim 22 wherein a first neighborhood includes a plurality of deployments and the first deployment is one of the first neighborhood deployments and, when the second deployment is one of the first neighborhood deployments, the one deployment assigns an active status to the data set provided to the first deployment and when the second deployment is other than a first neighborhood deployment, the one deployment assigns a hibernating status to the data set.

25. The assembly of claim 21 wherein the originator of a data set is the owner of the data set.

26. A method for controlling access to data by a plurality of linked deployments, the method comprising the steps of:
assigning at least a first subset of the deployments to one of a first neighborhood and a first community wherein the first deployment subset includes a first deployment;
originating a first data set that includes data items at a second deployment;
providing the first data set to the first deployment;
where the second deployment is a first deployment subset, rendering the first data set and data items in the first data set accessible at the first deployment; and
where the second deployment is other than a first deployment subset, rendering the first data set inaccessible at the first deployment and rendering the data items in the first data set accessible at the first deployment.

27. The method of claim 26 further including the steps of defining at least one exception condition and overriding the step of rendering the first data set accessible when the at least one exception condition occurs so that the first data set is inaccessible.

28. The method of claim 26 wherein the step of providing the first data set to the first deployment further includes providing the first data set to a plurality of the deployments and wherein the rendering steps are performed for each of the deployments that receives the first data set.

29. The method of claim 27 wherein each deployment that receives the first data set independently performs the rendering steps.

30. An information management method for use with at least a first deployment that includes at least one data structure, the method comprising the steps of:
storing a plurality of data sets on the data structure where each data set includes data items;
assigning an active status to at least a first subset of the data sets;
assigning a hibernating status to at least a second subset of the data sets;
wherein active data sets and items within active data sets are accessible via both selection by a system user and via reference within other data sets; and
wherein hibernating data sets and items within hibernating data sets are only accessible via reference from within other data sets.

31. The method of claim 30 wherein hibernating data sets and items within hibernating data sets are only accessible via references from within other data sets where the references were established prior to the hibernating data set being rendered hibernating.

32. The method of claim 30 wherein, when the system is used to search for a specific data set, active data sets are included in the search and hibernating data sets are excluded from the search and wherein search results only include data items associated with the active data sets and exclude data items from the hibernating data sets.

33. The method of claim 30 wherein an active data set can be rendered hibernating and wherein references to an active data set and data items in the active data set that are made in other data sets become references to a hibernating data set and data items in the hibernating data set after the active data set is rendered hibernating.

34. The method of claim 33 wherein additional references to hibernating data sets cannot be made after an active data set is rendered hibernating.

35. The method of claim 30 for use with a plurality of linked deployments that periodically originate and provide data sets to other deployments wherein the steps of assigning include assigning status as a function of the identity of the data set originating deployment.

36. The method of claim 32 further including the step of assigning a subset of the deployments including the first deployment to a first neighborhood, the step of assigning including, when a data set originated by a first neighborhood deployment is provided to the first deployment, assigning an active status to the new data set for the first deployment and, when a data set originated by a deployment other than a first neighborhood deployment is provided to the first deployment, assigning a hibernating status to the new data set for the first deployment.

37. The method of claim 30 including manually altering the status of at least one data set.

38. An information management method for use with at least first and second linked deployments where the first deployment includes at leas one data structure, the method comprising the steps of:
using the second deployment to originate a data set where the data set includes data items;
providing the originated data set to the first deployment; and
assigning one of a hibernating status and an active status to the data set at the first deployment;
wherein active data sets and items within active data sets are accessible both via selection by a system user and via reference within other data sets; and
wherein hibernating data sets and items within hibernating data sets are only accessible via reference from within other data sets.

39. The method of claim 38 wherein data items in active data sets and data items in hibernating data sets are accessible.

40. The method of claim 38 wherein a first neighborhood includes a plurality of deployments and the first deployment is one of the first neighborhood deployments and, when the second deployment is one of the first neighborhood deployments, the assigning step includes assigning an active status to the data set and when the second deployment is other than a first neighborhood deployment, the assigning step includes assigning a hibernating status to the data set.

41. The method of claim 38 wherein hibernating data sets and items within hibernating data sets are only accessible via references from within other data sets where the references were established prior to the hibernating data set being rendered hibernating.
